(19) United States
(12) Patent Application Publication
(10) Pub. No.: US 2009/0308896 A1
(43) Pub. Date: Dec. 17, 2009

(54) Venting System for Battery Operated Sprayer

(75) Inventor: Jeffrey P. Stark, Lake Sherwood, MO (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: CONTINENTALAFA DISPENSING COMPANY, St. Peters, MO (US)

(21) Appl. No.: 12/138,885

(22) Filed: Jun. 13, 2008

(51) Int. Cl. B05B 11/00; B67D 5/40; B05B 9/01; B05B 9/043; B67D 5/44

(52) U.S. Cl. 222/333; 222/383.1; 239/333; 239/332

(57) ABSTRACT

A venting system for a trigger sprayer includes an elongate vent member positioned in a vent hole in a closure cap of the trigger sprayer and a trigger actuator that is connected by a pivot connection to the trigger sprayer. The pivot connection of the trigger actuator is in close proximity to the vent member and the vent hole, and a finger engaging surface on the trigger actuator extends away from the pivot connection and away from the closure cap. Manipulating the trigger actuator toward the trigger sprayer causes the trigger actuator to pivot about the pivot connection and push the vent member into the vent opening of the closure cap, thereby opening a vent pathway through the closure cap. Releasing the trigger actuator allows the trigger to pivot away from the trigger sprayer and pull the vent member through the vent opening in the closure cap to close the vent pathway.

### BACKGROUND OF THE INVENTION

1. Field of the Invention

The present invention pertains to a handheld and hand operated liquid sprayer commonly called a trigger sprayer. In particular, the present invention pertains to a venting system for a trigger sprayer that has a novel and simplified construction. The venting system is described herein as being employed with a trigger sprayer that has a pump mechanism that is selectively driven by an electric motor powered by a battery. However, the venting system of the invention may be employed with most any type of trigger sprayer that is connected to a liquid container, and that also includes a manually operated trigger that is manipulated to dispense liquid from the container by the trigger sprayer.

The novel construction of the venting system includes a vent hole in a closure cap of the trigger sprayer and an elongate vent member positioned in the vent hole. The vent member is capable of reciprocating movement in the vent hole and is operatively connected to a trigger that has a novel construction and is part of the venting system of the invention.

The trigger is connected by a pivot connection to the trigger sprayer at a position adjacent the closure cap. Manually manipulating the trigger toward the trigger sprayer causes the trigger to pivot about the pivot connection and also causes the trigger to push the vent member into the vent opening of the closure cap, thereby opening a vent pathway through the closure cap. Releasing the trigger allows the trigger to pivot away from the trigger sprayer and causes the trigger to pull the vent member through the vent opening in the closure cap to close the vent pathway.

2. Description of the Related Art

Handheld and hand operated liquid sprayers commonly known as trigger sprayers are well known in the liquid sprayer art. Trigger sprayers are commonly used to dispense cleaning liquids by manually manipulating a trigger on the trigger sprayer. The trigger sprayer is typically connected to a plastic bottle containing the liquid. As liquid is dispensed from the bottle by the trigger sprayer, a vacuum pressure builds in the bottle. This vacuum pressure must be relieved to avoid the collapse of the plastic bottle. Thus, the typical trigger sprayer is provided with some system of venting the interior of the liquid container connected to the trigger sprayer. This allows air to enter the container interior and occupy that portion of the internal volume of the container that is vacated by the liquid dispensed from the container by the trigger sprayer.

Many different types of trigger sprayer venting systems have been developed. For example, trigger sprayers have been designed with vent holes in the sprayer housings that communicate through a vent pathway in the sprayer housing with the interior of the liquid container connected to the sprayer housing.

In some types of trigger sprayers, a flexible diaphragm valve is usually positioned over the vent hole. The pump piston rod of the sprayer has a plunger that projects from the bottom of the piston rod of the sprayer. The plunger curves toward the sprayer housing with a distal end of the plunger being positioned just outside of the vent hole. On manual manipulation of the trigger, the plunger end is inserted through the vent hole and engages against the diaphragm valve, displacing the valve from its position over the vent hole. This vents the interior of the liquid container through the vent hole and through the vent pathway to the exterior environment of the trigger sprayer. On return movement of the trigger, the plunger is retracted out of the vent hole and the resilience of the diaphragm valve allows it to resume its position sealing over the vent hole.

Another type of prior art venting system employs a vent chamber on the sprayer housing and a vent piston that is operatively connected to the trigger of the trigger sprayer. The vent piston, like the previously described plunger, projects from the pump piston rod. A vent hole is provided in the side of the vent chamber and one or more small ribs are formed on the interior surface of the vent chamber in the area of the vent hole. The vent hole communicates through a vent pathway in the trigger sprayer with the interior of the container attached to the trigger sprayer. The vent piston curves beneath the pump piston rod and extends into the vent chamber where the vent piston engages in a sliding, sealing engagement with the interior surface of the vent chamber. As the trigger is manipulated, the vent piston is pushed through the vent chamber toward the vent hole and the ribs. The ribs engage the periphery of the vent piston and displace the periphery from the interior surface of the vent chamber, thereby communicating the exterior environment of the trigger sprayer past the exterior of the piston and the interior surface of the vent chamber and through the vent hole and the vent pathway of the sprayer housing to the interior of the liquid container.

Some trigger sprayer designs have eliminated the projecting plunger and the projecting vent piston rod that detract from the overall appearance of the trigger sprayer. These designs typically employ a vent piston that is coaxial with the pump piston of the trigger sprayer, and is moved by the pump piston rod of the trigger sprayer. The vent piston is moved through a vent chamber that is coaxial with the trigger sprayer pump chamber. The vent chamber communicates through a vent pathway in the sprayer housing with the interior of the liquid container. This double piston design eliminates a separate plunger arm or vent piston from the pump piston rod.

However, each of the prior art venting systems described above requires that the trigger sprayer housing be constructed with both a vent hole and a vent pathway that communicate the exterior of the sprayer housing with the interior of a liquid container attached to the sprayer housing. The requirement that the sprayer housing include a vent hole and a vent pathway to communicate the exterior environment of the trigger sprayer with the container interior adds to the structural features required by the sprayer housing and thereby adds to the manufacturing cost of the sprayer housing. Although some type of venting system is required for venting vacuum pressure from the interior of the liquid container, and a vent hole with a valve that opens and closes the vent hole is required for enabling venting the interior of the liquid container and preventing the unintended leakage of liquid from the container, the construction of the sprayer housing could be improved by eliminating the air vent flow path through the sprayer housing.

### SUMMARY OF THE INVENTION

The venting system of the present invention overcomes disadvantages associated with prior art trigger sprayer venting systems by eliminating the need for a vent air flow path through the sprayer housing of the trigger sprayer of the invention, and thereby simplifies the construction of the trigger sprayer. The simplified construction of the venting system reduces the cost of manufacturing the trigger sprayer.

The venting system of the invention is designed for use with substantially any type of manually operated trigger sprayer that is capable of discharging liquid from a container attached to the sprayer by the manual manipulation of a trigger actuator of the trigger sprayer. The venting system is described herein as being employed with a trigger sprayer that includes a liquid pump that draws liquid from a container attached to the trigger sprayer and dispenses the liquid through a nozzle assembly of the trigger sprayer. The pump is operated by a gear transmission system that is driven by an electric motor powered by a battery contained in the sprayer housing of the trigger sprayer. However, it should be understood that the venting system of the invention may be employed in trigger sprayers having the conventional construction of a pump chamber containing a pump piston that is operatively connected to the trigger of the trigger sprayer where the pump piston reciprocates in the pump chamber in response to manual manipulation of the trigger.

The venting system of the invention includes a vent hole that passes through a cover of a closure cap of the trigger sprayer. The closure cap is removably attached to the neck of a liquid container by a threaded connection, a bayonet connection, or other type of connection known in the art. The cover of the closure cap extends over the opening of the container neck. The closure cap supports the sprayer housing of the trigger sprayer on the attached liquid container, as is conventional. The vent hole in the closure cap communicates the interior of the container with the exterior environment of the trigger sprayer.

The trigger sprayer supported on the container by the closure cap can be of any conventional construction, or can be of a construction similar to that described herein. The trigger sprayer has an exterior housing that includes a pair of side housing shells. The housing shells are assembled together over opposite sides of the closure cap cover in attaching the trigger sprayer to the closure cap. The housing shells enclose a liquid flow path that extends from a dip tube connector on the closure cap cover, through the housing, to a liquid pump in the housing. The liquid pump in turn communicates with a nozzle assembly mounted on the housing. Operation of the liquid pump draws liquid through the liquid flow path to the pump, and then dispenses the liquid from the housing through the nozzle assembly.

The embodiment of the trigger sprayer described herein includes an electric motor operatively connected to the liquid pump by a gear mechanism. A battery contained in a battery compartment of the sprayer housing provides electric energy to the motor. On operation of the motor, the gear mechanism reciprocates a pump piston in a pump chamber of the liquid pump. Reciprocation of the pump piston draws liquid through the liquid flow path of the sprayer to the pump chamber, and discharges the liquid through the nozzle assembly.

A trigger actuator is part of the venting system of the invention. The trigger actuator is operatively connected through a switching mechanism between the battery and the electric motor. Manual manipulation of the trigger selectively operates the electric motor. The trigger actuator is mounted between the housing shells for movement between a discharge position of the trigger where the motor is activated and liquid is discharged by the trigger sprayer, and an at rest position of the trigger where the motor is not activated and liquid is not discharged from the trigger sprayer.

The novel construction of the trigger actuator includes a pivot connection of the trigger actuator to the sprayer housing, where the pivot connection is located adjacent the closure cap. As a result, a majority of the length of the trigger extends upwardly from the pivot connection away from the closure cap. This portion of the trigger provides the finger engagement surface of the trigger that is manually manipulated by an operator of the trigger sprayer. The trigger actuator also has a vent arm that projects from an opposite side of the pivot connection from the hand engaging surface of the trigger actuator. The vent arm extends from the pivot connection adjacent the cover of the closure cap. The length of the vent arm is substantially smaller than that of the hand engaging surface of the trigger, and a majority of the length of the trigger extends upwardly away from the closure cap and the pivot connection.

An elongate vent member extends through the vent hole of the closure cap. The vent member is received in the vent hole for movement between a closed position of the vent member relative to the vent hole where the vent member blocks the vent hole and closes communication between the exterior environment of the trigger sprayer and the interior of the liquid container attached to the trigger sprayer, and an opened position of the vent member relative to the vent hole where the vent member unblocks the vent hole and communication between the exterior environment of the trigger sprayer and the interior of the liquid container is reestablished. One end of the vent member is connected to the vent arm of the trigger actuator by a second pivot connection of the trigger actuator. The second pivot connection connects only the vent member to the trigger actuator, and thereby simplifies the operative connection of the trigger actuator with the vent member. The operative connection between the vent arm and the vent member causes the vent member to move to the closed position relative to the vent hole when the trigger actuator is moved to the at rest position, and causes the vent member to move to the opened position relative to the vent hole when the trigger actuator is moved to the discharge position.

Thus, the construction of the venting system of the invention provides a vent hole through the cover of the closure cap and eliminates a vent pathway through the sprayer housing, which is typically present in the construction of prior art trigger sprayers. Furthermore, the venting system provides a simplified operative connection between the trigger actuator and the vent member that is located adjacent the closure cap. The simplified operative connection between the trigger actuator and the vent member and the elimination of a vent pathway through the sprayer housing reduces the manufacturing costs of the vent system of the invention from that associated with prior art trigger sprayer venting systems.

### DESCRIPTION OF THE DRAWING FIGURES

Further features of the invention are set forth in the following detailed description of the preferred embodiment of the invention and in the drawing figures.

FIG. 1 of the drawing figures shows a side, partially sectioned view of the trigger sprayer venting system of the invention in the vent closed condition of the venting system.

FIG. 2 is a view similar to that of FIG. 1, but showing the venting system in the vent open condition of the system.

FIG. 3 is a partially disassembled perspective view of component parts of the trigger sprayer shown in FIGS. 1 and 2.

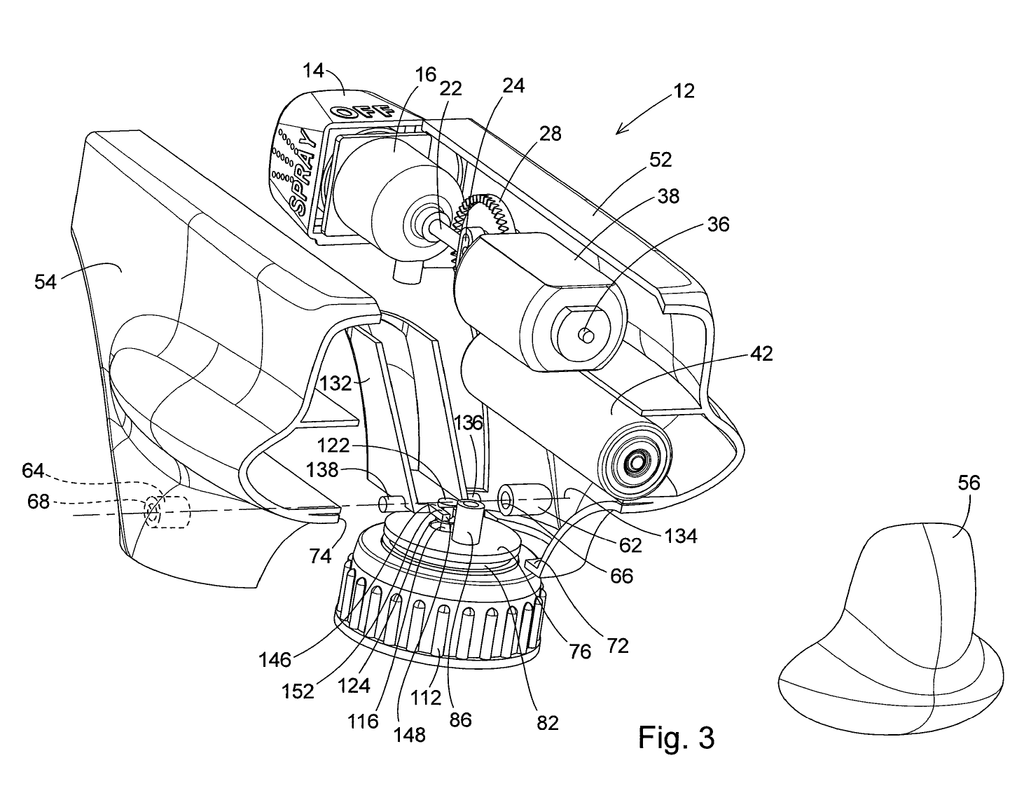

### DETAILED DESCRIPTION OF THE PREFERRED EMBODIMENT OF THE INVENTION

As stated earlier, the venting system of the invention is designed for use with substantially any type of manual operated trigger sprayer that is capable of discharging liquid from a container attached to the trigger sprayer by the manual manipulation of a trigger actuator of the trigger sprayer. Therefore, the construction of the trigger sprayer in which the venting system of the invention is employed will be described only generally, except for those component parts that are associated with the venting system.

Referring to the drawing figures, the trigger sprayer assembly 12 includes a nozzle assembly 14. In the preferred embodiment, the nozzle assembly 14 is of a known type that includes a nozzle cap that is rotatable relative to a nozzle base between an off position, a spray position, a foam position, and a stream position. In the off position, liquid discharge from the nozzle assembly is prevented. In the spray position, the liquid discharge from the nozzle assembly is in a spray pattern. In the foam position, the liquid is discharged as a foam. In the stream position the liquid discharge from the nozzle assembly is in a stream pattern. Nozzle assemblies 14 of the type described above are conventional and well known in the art.

The nozzle assembly 14 communicates with a liquid pump of any conventional construction. The pump is shown schematically in the drawings and is basically comprised of a pump chamber 16 and a pump piston 18 mounted in the pump chamber 16 for reciprocating movements. A piston rod 22 extends from the pump piston 18 to the exterior of the pump chamber 16. Reciprocation of the piston rod 22 causes movement of the pump piston 18 between charge and discharge positions of the piston in the pump chamber 16. When the pump piston 18 is moved to the discharge position in the pump chamber 16, liquid is discharged from the pump chamber through the nozzle assembly 14. When the pump piston 18 is moved to the charge position in the pump chamber 16, liquid is not discharged from the nozzle assembly 14 but is drawn to the pump chamber 16 from a liquid container attached to the trigger sprayer assembly 12. Because the venting system of the invention may be employed with substantially any type of trigger sprayer assembly, the pump chamber 16, pump piston 18 and pump piston rod 22 are shown only schematically in the drawing figures.

The piston rod 18 is provided with a cam slot 24 on an opposite end of the piston rod 22 from the pump piston 18. The cam slot 24 has an elongate length that is oriented perpendicular to the length of the piston rod 22.

The pump piston rod 22 is operatively connected to a gear transmission mechanism that includes a drive gear 26, a driven gear 28, and a cam pin 32. The cam pin 32 is positioned in the piston rod cam slot 24 for sliding movement through the length of the slot. The cam pin 32 is also positioned eccentrically on the driven gear 28 relative to the rotation axis (not shown) of the gear. On rotation of the driven gear 28 about the rotation axis (not shown), the cam pin 32 is caused to slide through the cam slot 24 and converts the rotation of the driven gear 28 to linear reciprocating movement of the piston rod 22. The drive gear 26 has a rotation axis (not shown) that is oriented perpendicular to the axis of the driven gear 28. Rotation of the drive gear 26 causes the rotation of the driven gear 28 which in turn causes the cam pin 32 to slide through the length of the piston rod cam slot 24.

The drive gear 26 is mounted on an output shaft 36 of an electric motor 38. Selective operation of the electric motor 38 causes the output shaft 36 to rotate the drive gear 26.

A dry cell battery 42 is operatively connected with the electric motor 38 through a switching mechanism (not shown). The battery 42 provides the electric energy for operation of the electric motor 38 in a conventional manner.

A liquid supply passage 44 communicates with the pump chamber 16 and supplies the pump chamber 16 with liquid from the separate liquid container connected to the trigger sprayer 12. The supply passage 44 has a tubular length with opposite proximal 46 and distal 48 ends. The distal end 48 of the liquid supply passage 44 is connected in liquid communication with the pump chamber 16. Although not shown in the drawing figures, one or more valves would be provided along the liquid flow path defined by the liquid supply passage 44 to control the flow of liquid to the pump chamber 16, and prevent the reverse direction of liquid flow.

The above-described component parts of the trigger sprayer assembly 22 are enclosed in a sprayer housing. The housing includes a first housing side shell 52, a second housing side shell 54 and a housing battery cover 56. As shown in the drawing figures, the first 52 and second 54 housing side shells support the nozzle assembly 14, the pump chamber 16, the driven gear 28, the electric motor 38, and the battery 42 in their relative positions between the two side shells 52, 54. In addition, the side shells 52, 54 completely enclose the pump chamber 16, the piston rod 22, the drive gear 26, the driven gear 28, the cam pin 32, the electric motor 38 and the motor output shaft 36, the battery 42 and the liquid supply passage 44 between the two shells. The housing battery cover 56 is removably attachable to the two housing side shells 52, 54 to provide access to the battery 42 inside the shells.

In addition to the above, the two housing side shells 52, 54 provide a portion of a first pivot connection of the venting assembly of the invention. Each of the housing side shells 52, 54 has a respective tubular projection 62, 64 that projects from an interior surface of the shell. The tubular projections 62, 64 contain coaxial holes 66, 68, respectively. Each of the housing shells 52, 54 has a respective arcuate flange 72, 74 at the bottoms of the shells that are employed in connecting the trigger sprayer assembly 12 to the venting system of the invention.

The venting system of the invention includes a disk-shaped closure cover 76. The closure cover 76 is dimensioned to cover over the opening of the neck of a liquid container attached to the trigger sprayer assembly 12. The closure cover 76 is circular and has a center axis 78 that is coaxial with a center axis of the liquid container neck when the trigger sprayer assembly 12 is attached to the liquid container. The axis 78 defines mutually perpendicular axial and radial directions relative to the trigger sprayer assembly 12 and the venting system of the invention.

The closure cover 76 also includes a cylindrical side wall 82 that is coaxial with the cover center axis 78. The side wall 82 has a bottom annular flange 84 that projects radially outwardly from the side wall 82.

A tubular liquid passage connector 86 projects axially from one side of the closure cover 76 and a tubular dip tube connector 88 projects axially from the opposite side of the closure cover 76. A hollow interior bore 92 extends through both the liquid passage connector 86 and the dip tube connector 88 and has a center axis 94 that is parallel to the closure cover axis 78. The liquid passage connector 86 is connected to the proximal end 46 of the liquid supply passage 44, and the dip tube connector 88 is adapted to receive a dip tube (not shown) that is inserted into the interior of the liquid container attached to the trigger sprayer assembly 12.

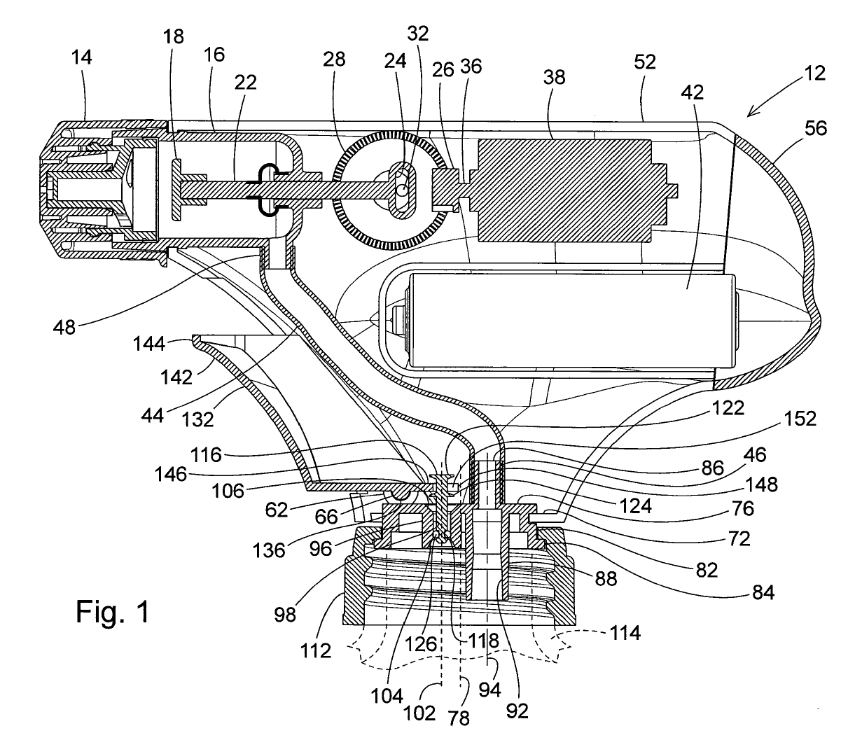

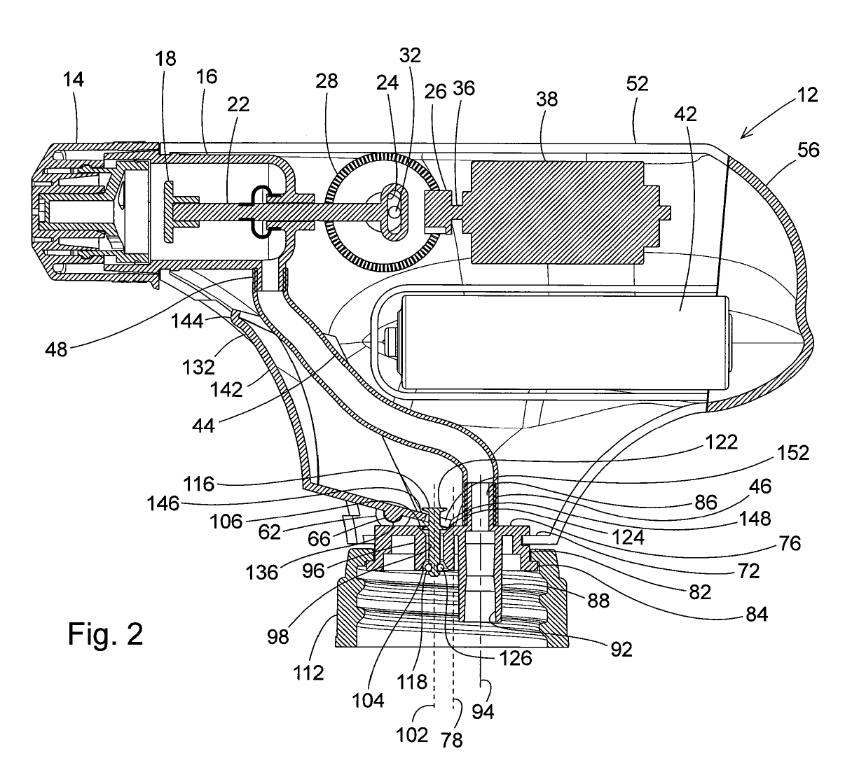

A tubular vent housing 96 also projects from the side of the closure cover 76 adjacent the dip tube connector 88. A vent hole 98 extends through the vent housing 96. The vent hole 98 has a center axis 102 that is parallel and spaced from the closure cover center axis 78 and the center axis 94 of the liquid passage connector and dip tube connector interior bore 92. As can be seen in FIGS. 1 and 2, the vent hole 98 has a tapered bottom seating surface 104 and a tapered top surface 106 at axially opposite ends of the vent hole 98.

A closure cap 112 is mounted on the closure cover 46. In the embodiment shown in FIGS. 1 and 2, the closure cap 112 is an internally threaded cap that is mounted on the closure cover side wall 82 and annular flange 84 for rotation of the cap relative to the closure cover 76. The closure cap 112 is rotated on complementary external screw threading on the liquid container neck 114 to attach the trigger sprayer assembly 12 to the liquid container. Alternatively, the closure cap 112 could have a bayonet-type fitment or other equivalent attachment connecting the trigger sprayer assembly to the liquid container. The cap 112 could also be formed integrally with the closure cover 76.

A vent member 116 is mounted in the vent hole 98 of the closure cover 76. The vent member 116 has an elongate length that is received in the vent hole 98 for axially reciprocating movement along the axis 112 of the vent hole 98. In the preferred embodiment, the vent member 116 has a cylindrical exterior surface along the axial length of the vent member except for an annular groove 118 formed in the vent member adjacent a bottom end of the vent member shown in FIGS. 1 and 2, and a pair of annular radial projections or lips 122, 124 formed at the top end of the vent member 116 as shown in FIGS. 1 and 2.

A resilient circular seal 126, for example an O-ring, is mounted on the bottom end of the vent member 116 as viewed in FIGS. 1 and 2. The resilience of the seal 126 holds the seal in the annular groove 118 formed in the vent member 116. With the seal 126 positioned in the groove 118, the seal forms a third annular radial projection or lip on the vent member 116. As seen in FIGS. 1 and 2, the axial positions of the pair of annular projections or lips 122,124 and the circular seal 127 on the length of the vent member 116 permit the limited axial movement of the vent member 116 through the vent hole 98. FIG. 1 shows the vent member 116 moved to a closed position relative to the sprayer assembly 12. In this position the circular seal 126 engages against the tapered bottom surface 102 of the vent hole 98 and closes a venting air flow path between the exterior environment of the trigger sprayer assembly 12 and the interior of a liquid container 114 secured to the closure cap 112. FIG. 2 shows the vent member 116 moved to the opened position of the vent member in the vent hole 98, where the circular seal 126 disengages from the tapered bottom surface 104 of the vent hole 98 and opens or reestablishes a venting air flow path from the exterior environment of the sprayer assembly 12 to the interior of a bottle container 114 attached to the closure cap 112.

The venting system of the invention also includes a trigger actuator 132 that is mounted to the trigger sprayer assembly 12 for pivoting movement. The trigger actuator 132 is operatively connected through a switching mechanism (not shown) between the battery 42 and the electric motor 38. Manual manipulation of the trigger actuator 132 selectively operates the electric motor 38. As explained earlier, selective operation of the electric motor 38 causes the pump piston 18 to reciprocate in the pump chamber 16 and thereby discharges liquid through the nozzle assembly 14.

The trigger actuator 132 is mounted by a pivot connection to the trigger sprayer assembly 12 for pivoting movement of the actuator about a pivot axis 134. The trigger actuator 132 pivots between a discharge position where the electric motor 38 is selectively operated, and an at rest position where the motor is not operated. A spring (not shown) urges the trigger actuator to the at rest position. The pivot connection includes a pair of pivot posts 136, 138 that project coaxially from opposite sides of the trigger actuator 132. The pair of posts 136, 138 are received in the respective holes 66, 68 in the tubular projections 62, 64 that project from the interior surfaces of the two housing shells 52, 58. In alternate embodiments of the pivot connection, the housing shells 52, 58 could be provided with pivot posts that extend into tubular holes provided in the opposite sides of the trigger actuator 132. The pivot connection provided by the pair of posts 136, 138 extending into the pair of tube holes 66, 68 enables the trigger actuator 132 to pivot about the pivot axis 134 between the discharge position of the trigger actuator 132 relative to the trigger sprayer assembly 12 shown in FIG. 2, and the at rest position of the trigger actuator 132 relative to the trigger sprayer assembly 12 shown in FIG. 1. The pivot connection provided by the posts 136, 138 and the tube holes 66, 68 is positioned closely adjacent to the closure cover 76 as seen in FIGS. 1 and 2.

With the positioning of the pivot connection of the trigger actuator 132 closely adjacent the closure cover 76, a majority of the length of the trigger actuator 132 extends upwardly from the pivot connection away from the closure cap 112 as shown in the drawing figures. This portion of the trigger actuator 132 that extends upwardly from the pivot connection forms a finger engagement surface 142 that is positioned on the trigger actuator 132 where the surface 142 is easily engaged by the fingers of a user's hand holding the trigger sprayer assembly 12. This finger engagement surface 142 has a first length that extends from adjacent the pivot connection, upwardly across the trigger actuator 132 to a distal end 144 of the engagement surface at the top of the trigger actuator as shown in the drawing figures.

The trigger actuator 132 also has a vent arm 146 that projects from an opposite side of the pivot connection from the hand engaging surface 142. The vent arm 146 has a second length that extends from the pivot connection over the closure cover 76 to a distal end 148 of the vent arm. The second length of the vent arm 146 is substantially smaller than the first length of the finger engagement surface 142. As seen in the drawing figures, the second length of the vent arm 146 is also positioned at an angle relative to the first length of the finger engagement surface 142. The vent arm 146 is formed as a pair of fork tines 152 at the arm distal end 148. The tines 152 extend across opposite sides of the vent member 116 between the upper pair of annular projections 122, 124 on the vent member. This positioning of the pair of tines 152 forms a second pivoting connection of the trigger actuator 132 that operatively connects the trigger actuator 132 with the vent member 116. This second pivot connection provided by the tines 152 extending between the pair of annular projections 122, 124 enables the vent member 116 to pivot relative to the trigger actuator 132 in response to the trigger actuator 132 being moved between the discharge and at rest positions. This positioning of the vent member 116 in close proximity to the trigger actuator 132 simplifies and reduces the cost of the venting system of the invention. The operative connection between the vent arm 136 and the vent member 116 causes the vent member 116 to move to the closed position shown in FIG. 1 relative to the vent hole 98 when the trigger actuator 132 is moved to the at rest position, and causes the vent member 116 to move to the opened position shown in FIG. 2 relative to the vent hole 98 when the trigger actuator 132 is moved to the discharge position.

Thus, the construction of the venting system of the invention provides a vent hole 98 through the cover 76 of the closure cap 112 and eliminates any vent pathway through the sprayer housing, which is typically present in the construction of prior art trigger sprayers. Furthermore, the venting system provides a simplified operative connection between the trigger actuator 132 and the vent member 116 that is located adjacent the closure cap 112. The simplified operative connection between the trigger actuator 132 and the vent member 116 and the elimination of a vent pathway through the sprayer housing reduces the manufacturing costs of the vent system of the invention from that associated with prior art trigger sprayer venting systems.

Although the venting system of the invention has been described above by referring to a specific embodiment of a trigger sprayer assembly, it should be understood that variations and modifications could be made to the venting system without departing from the intended scope of the following claims.

1) A venting system of a trigger sprayer apparatus comprising:
a sprayer assembly that is connectable to a liquid container, the sprayer assembly having a vent hole that communicates an exterior environment of the trigger sprayer with an interior of the liquid container when the sprayer assembly is connected to the liquid container;
a vent member in the vent hole, the vent member being movable relative to the vent hole between a closed position where communication between the exterior environment and the liquid container interior through the vent hole is blocked, and an opened position where communication between the exterior environment and the liquid container interior through the vent hole is unblocked;
a liquid pump in the sprayer assembly, the liquid pump being operable to pump liquid from the liquid container connected to the sprayer assembly and discharge the liquid from the sprayer assembly;
a trigger actuator operatively connected to the liquid pump, the trigger actuator being mounted by a pivot connection to the sprayer assembly, the pivot connection having a pivot axis and the trigger actuator being pivotable about the pivot axis between a discharge position of the trigger actuator relative to the sprayer assembly where the liquid pump is operated to discharge liquid from the sprayer assembly, and an at rest position of the trigger actuator relative to the sprayer assembly where the liquid pump is not operated to discharge liquid from the sprayer assembly, the trigger actuator having a hand engaging surface positioned on one side of the pivot axis where the hand engaging surface is easily engaged by fingers of a user's hand holding the sprayer assembly, and the trigger actuator having a vent arm positioned on an opposite side of the pivot axis from the hand engaging surface where the vent arm is operatively connected to the vent member to cause the vent member to move to the closed and opened positions in response to the trigger actuator moving to the respective at rest and discharge positions.

2) The apparatus of claim 1, further comprising:
a pair of concentric posts on one of the sprayer assembly and the trigger actuator, the pair of posts being coaxial with the pivot axis, and a pair of holes on the other of the sprayer assembly and the trigger actuator, the pair of posts extending into the pair of holes and thereby providing the pivot connection of the trigger actuator to the sprayer assembly.

3) The apparatus of claim 2, further comprising:
the sprayer assembly having a pair of housing shells that enclose the vent member and the liquid pump between the pair of shells, and one of the pair of posts and the pair of holes being on the pair of housing shells.

4) The apparatus of claim 1, further comprising:
the trigger actuator hand engaging surface having a first length that extends from a proximal end of the hand engaging surface adjacent the pivot connection to an opposite distal end of the hand engaging surface, and the trigger actuator having a second length that extends from a proximal end of the vent arm adjacent the pivot connection to an opposite distal end of the vent arm, and the first length being larger than the second length.

5) The apparatus of claim 1, further comprising:
the trigger actuator hand engaging surface extending away from the pivot axis in a first direction, the trigger actuator vent arm extending away from the pivot axis in a second direction, and the first and second directions being oriented at an angle.

6) The apparatus of claim 1, further comprising:
the vent arm being operatively connected to the vent member to allow relative movement between the vent arm and vent member in response to the trigger actuator moving between the discharge position and the at rest position of the trigger actuator relative to the sprayer assembly.

7) The apparatus of claim 1, further comprising:
the sprayer assembly having a closure cap that is operable to connect the sprayer assembly to a liquid container, the closure cap having a center axis; and,
the vent hole having a center axis that is parallel with the closure cap center axis.

8) The apparatus of claim 1, further comprising:
an electric motor in the sprayer assembly, the electric motor being operatively connected to the trigger actuator and the liquid pump to operate the liquid pump in response to operation of the electric motor.

9) A venting system of a trigger sprayer apparatus comprising:
a sprayer assembly having a closure cap that is connectable to a liquid container and a closure cover that covers over an opening of the liquid container when the closure cap is connected to the liquid container, the closure cover having a vent hole through the closure cover that communicates an exterior environment of the trigger sprayer with an interior of the liquid container when the sprayer assembly is connected to the liquid container;
a vent member extending through the vent hole, the vent member being movable in the vent hole between a closed position where the vent member blocks the vent hole and communication between the exterior environment and the interior of the liquid container through the vent hole is blocked, and an opened position where the vent member is removed from blocking the vent hole and communication between the exterior environment and the interior of the liquid container through the vent hole is unblocked;
a liquid pump in the sprayer assembly, the liquid pump being operable to pump liquid from a liquid container connected to the closure cap and discharge the liquid from the sprayer assembly;
a trigger actuator operatively connected to the liquid pump, the trigger actuator being mounted on the sprayer assembly for movement of the trigger actuator between a discharge position of the trigger actuator relative to the sprayer assembly where the liquid pump is operated to discharge liquid from the sprayer assembly, and an at rest position of the trigger actuator relative to the sprayer assembly where the liquid pump is not operated to discharge liquid from the sprayer assembly, the trigger actuator being operatively connected to the vent member to cause the vent member to move between the opened position and the closed position in response to the trigger actuator moving between the respective discharge position and the at rest position.

10) The apparatus of claim 9, further comprising:
the trigger actuator being connected by a pivot connection to the sprayer assembly, the trigger actuator having a hand engaging surface that is positioned on one side of the pivot connection to be easily engaged by fingers of a user's hand holding the trigger sprayer, and the trigger actuator being operatively connected to the vent member on an opposite side of the pivot connection from the hand engaging surface.

11) The apparatus of claim 9, further comprising:
the sprayer assembly having a pair of housing shells that engage around the closure cover and enclose the vent member and the liquid pump between the pair of shells.

12) The apparatus of claim 9, further comprising:
an electric motor in the sprayer assembly, the electric motor being operatively connected to the liquid pump and the trigger actuator to cause operation of the liquid pump in response to the trigger being moved to the discharge position.

13) The apparatus of claim 9, further comprising:
the closure cover having a liquid passage interior bore through the closure cover, the liquid passage interior bore being adjacent and spaced from the vent hole.

14) A venting system for a trigger sprayer apparatus comprising:
a sprayer assembly that is connectable to a liquid container, the sprayer assembly having a vent hole that communicates an exterior environment of the trigger sprayer with an interior of the liquid container when the sprayer assembly is connected to the liquid container;
a vent member in the vent hole, the vent member having a straight length with opposite proximal and distal ends, the vent member being movable in the vent hole between a closed position where communication between the exterior environment and the interior of the liquid container through the vent hole is blocked by the vent member, and an opened position where communication between the exterior environment and the interior of the liquid container through the vent hole is unblocked;
a liquid pump in the sprayer assembly, the liquid pump being operable to pump liquid from a liquid container connected to the sprayer assembly and discharge the liquid from the sprayer assembly;
a trigger actuator operatively connected to the liquid pump, the trigger actuator being mounted by a first pivot connection to the sprayer assembly for movement of the trigger actuator between a discharge position of the trigger actuator relative to the sprayer assembly where the liquid pump is operated to discharge liquid from the sprayer assembly, and an at rest position of the trigger actuator relative to the sprayer assembly where the liquid pump is not operated to discharge liquid from the sprayer assembly, the trigger actuator being connected by a second pivot connection to the vent member to cause the vent member to move between the opened position and the closed position in response to the trigger actuator moving between the respective discharge position and the at rest position, the second pivot connection connecting only the vent member to the trigger actuator.

15) The apparatus of claim 14, further comprising:
the straight length of the vent member having a cylindrical exterior surface with a first annular lip projecting outwardly from the cylindrical surface at the vent member proximal end and a second annular lip projecting outwardly from the cylindrical surface at the vent member distal end.

16) The apparatus of claim 15, further comprising:
the first annular lip and the second annular lip being at opposite ends of the vent hole.

17) The apparatus of claim 15, further comprising:
the vent hole having a seating surface around the vent hole; and,
the second annular lip on the vent member engaging against the seating surface in response to the trigger actuator moving to the at rest position, and the second annular lip being disengaged from the seating surface in response to the trigger actuator being moved to the discharge position.

18) The apparatus of claim 14, further comprising:
an electric motor in the sprayer assembly, the electric motor being operatively connected to the trigger actuator and the liquid pump to operate the liquid pump in response to operation of the electric motor.

19) The apparatus of claim 14, further comprising:
the trigger actuator having a hand engaging surface that is positioned on one side of the pivot connection to be easily engaged by fingers of a user's hand holding the trigger sprayer, and the trigger actuator being operatively connected to the vent member on an opposite side of the pivot connection from the hand engaging surface.

20) The apparatus of claim 14, further comprising:
the sprayer assembly having a pair of housing shells on opposite sides of the trigger actuator, and the trigger actuator being connected to the pair of housing shells by the first pivot connection.

21) The apparatus of claim 18, further comprising:
the trigger actuator having a pair of fork tines that project from an opposite side of the pivot connection from the hand engaging surface, the pair of tines extending across opposite sides of the vent member exterior surface between the first and second annular lips, thereby providing the second pivot connection between the trigger actuator and the vent member.
